(19) United States
(12) Patent Application Publication
(10) Pub. No.: US 2008/0161969 A1
(43) Pub. Date: Jul. 3, 2008

(54) Method for routing a robotic apparatus to a service station and robotic apparatus service system using thereof

(75) Inventors: Shih-Ping Lee, Taichung County (TW); Yu-Liang Chung, Taipei City (TW); Long-Der Chen, Hsinchu City (TW); Hung-Hsiu Yu, Changhua County (TW); Ching-Chi Liao, Taichung County (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/783,704

(22) Filed: Apr. 11, 2007

(30) Foreign Application Priority Data
Dec. 28, 2006 (TW) 095149425

(51) Int. Cl. G06F 19/00

(52) U.S. Cl. 700/245; 318/568.12

(57) ABSTRACT

A method for routing a robotic apparatus to a service station and robotic apparatus service system using thereof are disclosed in the present invention, wherein the system comprises at least one service station and a robotic apparatus. The service station is capable of providing charging service and has a signal emitter array which functions to emit communication signals for guiding the robotic apparatus back to the service station. The robotic apparatus has a signal receiver for searching and detecting the communication signal emitted from the service station and determines the moving direction according to the intensity of the communication signal received by the signal receiver so as to arrive at the service station smoothly through the method disclosed in the present invention. Once the robotic apparatus arrives at the service station, the service station may provide service such as charging to the robotic apparatus while the robotic apparatus may standby to wait for the accomplishment of charging. By means of the method and system provided in the present invention, the robotic apparatus may route to the service station in a shortest way by rectilineal motion and contact to the service station to receive the service in arbitrary angle.

### FIELD OF THE INVENTION

The present invention relates to a path guidance method and system, and more particularly, to a robotic apparatus service method and system capable of enabling a robotic apparatus to received a radio wave guidance signal issued from a signal emitter array of a service station by at least a signal receiver arranged thereon, and thereby, guiding the robotic apparatus to move toward the service station to be served by the service station.

### BACKGROUND OF THE INVENTION

Conventionally, a robotic apparatus can be defined as an automatically controlled, mobile device which is capable of being programmed to execute at least a task within a specific working area. Usually, one such robotic apparatus, e.g. a mobile robot, is a self-reliance device that is moving and operating by a built-in power source, whereas the built-in power source can be a rechargeable battery. Thus, in order to keep a mobile robot operational, it must return to a service station for charging its rechargeable battery before its power is running out, or after the total operating time of the robotic apparatus reaches a predefined limit. Nevertheless, How to enable a robotic apparatus to aware the exact position of its service station is an must-have ability for the robotic apparatus to guide itself correctly back to the service station before it ran out of power.

Take the robotic vacuum cleaner for instance, there are three types of path guidance methods usually being adopted thereby. The first type is a battery charging method disclosed in U.S. Pub. No. 20050231156, entitled “Mobile Robotic System and Battery Charging Method Thereof”, as shown in FIG. 1A. In FIG. 1A, the robotic vacuum cleaner 101 is associated with a set of charging devices 10 that are disposed at different locations so that the robotic vacuum cleaner 101 is able to locate one of the charging devices 10 within a relatively short amount of time so that battery charging can be conducted immediately when battery power runs low. When battery capacity of the robotic vacuum cleaner 101 had dropped and reached a predefined low electric potential, the robotic vacuum cleaner is directed to enter a wall-following mode until it runs into and detects an infrared light beam 100 emitted from the light emitter of one of the plural charging devices 10. As soon as the robotic vacuum cleaner detects the infrared light beam 100, the robotic vacuum cleaner 101 can be directed to move toward the charging device 10 by the guidance of the infrared light beam 100 for guiding the robotic vacuum cleaner 101 to establish contact with the charging electrodes of the charging device 10 correctly and thus completing the charging of the robotic vacuum cleaner 101. However, in actual practices, when the robotic vacuum cleaner 101 is situated in a complicated working environment, or even when the robotic vacuum cleaner 101 operating in the wall-following mode accidentally enters sections out of the coverage of the plural charging devices 10 as the wall-following mode can be misleading, the success rate of guiding the robotic vacuum cleaner 101 to establish contact with any charging device 10 can be very slim so that the aforesaid battery charging method is inefficiency and untrustworthy.

The second type of path guidance method is a method of docking a robotic device with a base station, disclosed in U.S. Pub. No. 20050156562, entitled “Autonomous Robot Auto-docking and Energy Management Systems and Methods”, as shown in FIG. 1B. Similar to that shown in FIG. 1A, a robotic device 111 is also guided by the infrared light beam emitted from a light emitter 116 of a base station 11 and thus routed back to the base station 116 for charging. The difference between the two is that: there are two infrared light beams 112, 113 of different characteristics being emitted by the light emitter 116 while the two infrared light beams 112, 113 are directed to overlapped by a signal-overlap area 114, by which, as soon as an infrared sensor 115 of the robotic device 111 detects the two infrared light beams 112, 113, the direction pointing to the base station 11 can be determined for directing the robotic device 111 to move toward the base station 11 so as to dock the robotic device 111 on the base station 11 for charging. However, in actual practices, the robotic device 111, operating within a larger area, is mostly working in a zone that is not covered by any infrared light beam emitted from any base station 11 since the coverage area of any infrared light beam is not large. Thus, in most case, it would take the robotic device 111 quite some times to search an infrared light beam for guiding itself back to the base station 11 for charging, so that the reliability of the aforesaid method is adversely affected and questioned.

The third type of path guidance method is a method of guidance and positioning relative to a fixed station for an autonomous mobile robot, disclosed in U.S. Pat. No. 6,389,329, entitled “Mobile Robots and Their Control System”. Similar to those shown in FIG. 1A and FIG. 1B, a robotic device is also guided by the infrared light beam emitted from a light emitter of a base station and thus routed back to the base station for charging. The difference is that: instead of one or two infrared light beams, there are three infrared light beams of different directionality emitted from a base station, by which, as soon as the two symmetrically disposed infrared sensors of the robotic device detect the infrared light beams, the direction pointing to the base station can be determined for directing the robotic device to move toward the base station so as to dock the robotic device on the base station for charging. Although the aforesaid method allows the guidance of the robot device in a more complex environment efficiently by a rectilineal motion and can provide a comparatively larger sensing range, the coverage of infrared light beams of the base station is still being restricted within a zone defined by a small angular range that is corresponding to the middle of the base station. Thus, the robotic device, operating within a larger area, is also mostly working in a zone that is not covered by any infrared light beam. Therefore, in most case, it would take the robotic device quite some times to search an infrared light beam for guiding itself back to the base station for charging, so that the reliability of the aforesaid method is adversely affected and questioned. In addition, the arranging of two infrared sensors will cause the manufacturing cost of the robotic device to increase and thus adversely affect its commercial competitiveness.

Therefore, it is in need of an improved method for routing a robotic apparatus to a service station and a robotic apparatus service system using the same that are free from the shortcomings of prior arts.

### SUMMARY OF THE INVENTION

It is an object of the present invention to provide a method for routing a robotic apparatus to a service station and a robotic apparatus service system using the same, in which by the detection of a most intense communication signal emitted from the service station, a moving direction can be determined for guiding the robotic apparatus back to the service station in a shortest way by rectilinear motion that is not only efficient, but also time-saving.

It is another object of the invention to provide a method for routing a robotic apparatus to a service station and a robotic apparatus service system using the same, in which by arranging a call unit of large emitting angle in a service station, the robotic apparatus can be routed back to the service station to be served thereby in arbitrary angle.

It is yet another object of the invention to provide a method for routing a robotic apparatus to a service station and a robotic apparatus service system using the same, in which by arranging a signal emitter array in a service station for increasing signal coverage, a robotic apparatus is able to detect and receive a communication signal emitted from the service station while operating at any location of a specified working area so as to utilize the communication signal as guidance for routing the robotic apparatus to the service station, so that less time is waste in the searching for the communication signal and thus the reliability as well as accuracy for routing the robotic apparatus to the service station are enhanced.

It is further another object of the invention to provide a method for routing a robotic apparatus to a service station and a robotic apparatus service system using the same, in which by the utilization of directional units to control the signal receiving range of a robotic apparatus, it is able to direct the robotic apparatus to move efficiently toward a service station in a rectilineal motion.

To achieve the above objects, the present invention provides a method for routing a robotic apparatus to a service station, comprising the steps of: enabling a robotic apparatus to search for a communication signal emitted from a service station; enabling the robotic apparatus to rotate for locating a moving direction pointing to the communication signal of maximum intensity; directing the robotic apparatus to move toward the service station by the guidance of the moving direction; and directing the service station to detect and determine whether the robotic apparatus reaches the service station; directing the service station to serve the robotic apparatus if the robotic apparatus reaches the service station.

To achieve the above objects, the present invention provides a robotic apparatus service system, comprising: at least a service station; at least a signal emitter array, each being respectively arranged on at least a side of each service station for structuring a communication zone by the communication signal emitted therefrom; a robotic apparatus, having a signal receiver and an electrode; and at least a charging unit, each being disposed on the at least one service station, capable of electrically connecting to the electrode of the robotic apparatus in arbitrary angle for charging the robotic apparatus; wherein the signal receiver is able to receive the communication signal as soon as the robotic apparatus enters the communication zone so as to direct the robotic apparatus to move toward the service station by the guidance of the communication signal.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1A is a schematic top view to illustrate a state in which a light sensor of a mobile robot detects light emitted by a light emitter of a charging device of the mobile robotic system disclosed in U.S. Pub. No. 20050231156.

FIG. 1B is a schematic perspective view of homing signals transmitted by the base station and detected by the robotic device, disclosed in U.S. Pub. No. 20050156562.

FIG. 2A is a flow chart illustrating steps of a method for routing a robotic apparatus to a service station according to a first embodiment of the invention.

FIG. 2B is a schematic diagram depicting the intensity distribution of a communication signal being detected by a robotic apparatus of the invention as it is being directed to rotate without moving.

FIG. 3A is a flow chart illustrating steps of a method for routing a robotic apparatus to a service station according to a second embodiment of the invention.

FIG. 3B shows a moving path of a robotic apparatus as it is being guided toward a service station by the use of the method of the invention.

FIG. 4 is a schematic perspective view of a robotic apparatus service system according to an embodiment of the invention.

FIG. 5 is a schematic perspective diagram showing a service station used in a robotic apparatus service system of the invention.

FIG. 6A and FIG. 6B are schematic diagrams respectively showing the signal emitter array of a service station and the communication zones structured thereby.

FIG. 7A is a schematic diagram illustrating the arrangement of a signal emitter array on a service station according to an embodiment of the invention.

FIG. 7B to FIG. 7E shows various types of service stations capable of being adopted by the present invention.

FIG. 8 is a schematic diagram showing that a robotic apparatus of the invention may route to a service station and contact to the service station to be charged in arbitrary angle.

FIG. 9A to FIG. 9C are perspective diagrams respectively showing three different arrangements for mounting a charging unit upon a service station of the invention.

FIG. 10 is a schematic diagram showing the application of a charging unit and a confirmation unit according to an embodiment of the invention.

FIG. 11 is a schematic view of a robotic apparatus of the invention.

FIG. 12A and FIG. 12B are schematic perspective views of a signal receiver and its directional unit, used in a robotic apparatus of the invention.

FIG. 13A and FIG. 13B are schematic top views respectively showing two different arrangements for mounting signal receivers upon a robotic apparatus of the invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

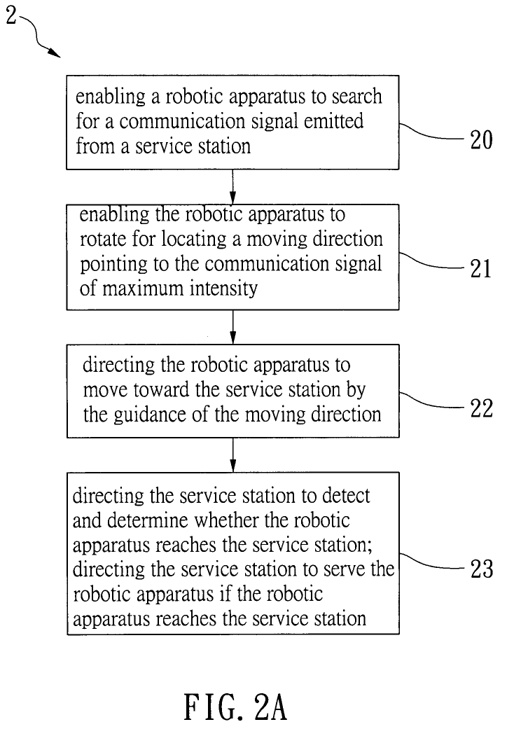

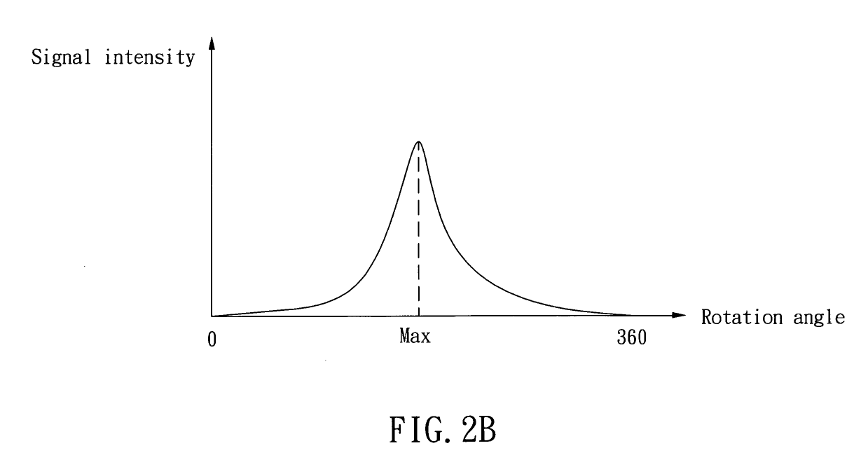

Please refer to FIG. 2A, which is a flow chart illustrating steps of a method for routing a robotic apparatus to a service station according to a first embodiment of the invention. The flow of the method starts from step 20. At step 20, a robotic apparatus is enabled to search for a communication signal emitted from a service station, whereas the robotic apparatus is able to search for a communication signal by a manner selected from the group consisting of: searching the communication signal dynamically while the robotic apparatus is on the move, directing the robotic apparatus to rotate without moving while searching the communication signal, and the combination thereof; and then the flow proceeds to step 21.

At step 21, the robotic apparatus is enabled to rotate for locating a moving direction pointing to the communication signal of maximum intensity, as that indicated in FIG. 2B, and then as soon as the moving direction pointing to the communication signal of maximum intensity is located, the flow proceeds to step 22. At step 22, the robotic apparatus is directed to move toward the service station by the guidance of the moving direction following a rectilinear motion; and then the flow proceeds to step 23.

It is noted that a movement confirmation process can be performed during the robotic apparatus is being directed to move toward the service station, which comprises the steps of: confirming the intensity of the communication signal; and detecting whether there is an obstacle blocking the way the robotic apparatus is moving toward the service station while evaluating the distance between the robotic apparatus and the service station. If unreasonable signal intensity is detected, the robotic apparatus is enabled to perform an orientation calibration process. Preferably, the orientation calibration process is performed in the manner that the robotic apparatus is being enabled to sway within in a specific angular range, and if it collides with an obstacle during the swaying, the robotic apparatus will enter an obstacle evading mode for maneuvering the same around the obstacle. Moreover, the distance between the robotic apparatus and the service station is evaluated with respect to the intensity of the communication signal, and thereby, the robotic apparatus is directed to decelerate while moving in the rectilineal motion if the distance is smaller than a specific value.

At step 23, the service station is directed to detect and determine whether the robotic apparatus reaches the service station; if so, the service station is directed to serve the robotic apparatus. In this embodiment, the detection of the arrival of the robotic apparatus is achieved by the detection of whether a service unit of the service station is in contact with the robotic apparatus. Except for the aforesaid contact manner, the detection can be achieved by a non-contact manner. For instance, by the non-contact techniques, such as electromagnetic induction, radio frequency communication; or acoustic sensing, an evaluation can be made to determine whether the robotic apparatus is approaching and in the neighborhood of the service station. It is noted that the service station can be a charging station, and the service unit can be a charging unit.

The robotic apparatus can be any mobile mechanical device, such as a robot, an automated guided vehicle, or a robotic vacuum cleaner, and so on. The service station can be a charging station, an air recharge station, or any other service station capable of providing various services including the aforesaid two.

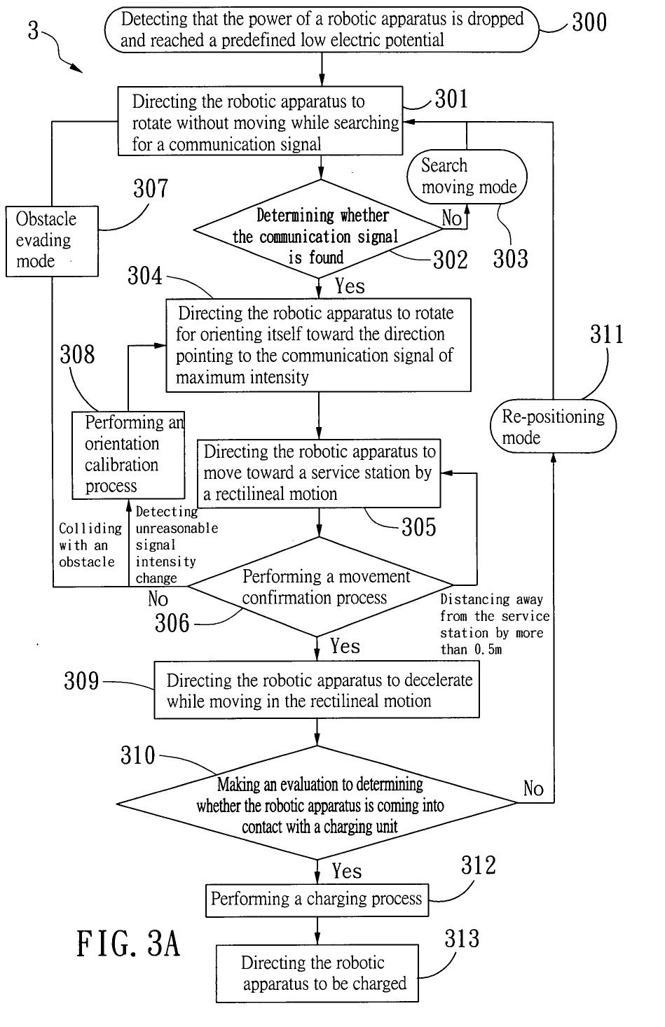

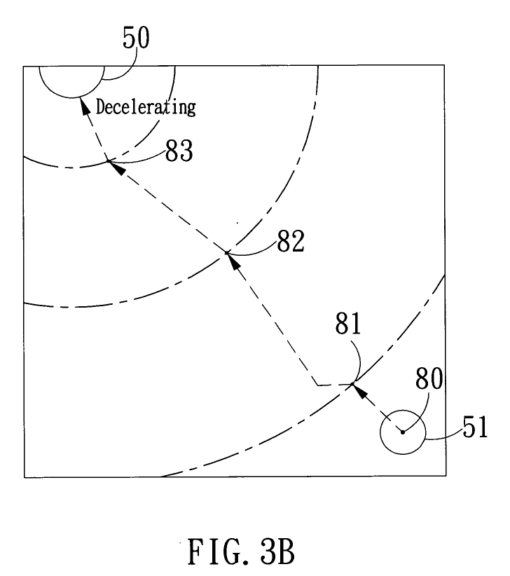

For clarity, the aforesaid routing method is applied for guiding a robotic vacuum cleaner back to a charging station for charging. Please refer to FIG. 3A, which is a flow chart illustrating steps of a method for routing a robotic vacuum cleaner to a service station according to a second embodiment of the invention. The flow starts from step 300. At step 300, the power of a robotic vacuum cleaner is detected and if it had dropped and reached a predefined low electric potential, the flow will proceed to step 301. At step 301, the robotic vacuum cleaner is directed to rotate without moving while searching for a communication signal; and then the flow proceeds to step 302. At step 302, an evaluation is being made for determining whether the communication signal is found; if so, the flow proceeds to step 304; otherwise, the flow proceeds to step 303. At step 303, the robotic vacuum cleaner is enabled to enter a search moving mode that the robotic vacuum cleaner is kept searching for the communication signal dynamically while the robotic vacuum cleaner is on the move; and then the flow proceeds back to step 301. At step 304, the robotic vacuum cleaner is enabled to rotate for orienting itself toward the direction pointing to the communication signal of maximum intensity, similar to that indicated in FIG. 2B, and then as soon as the moving direction pointing to the communication signal of maximum intensity is located, the flow proceeds to step 305. At step 305, the robotic vacuum cleaner is directed to move toward a service station by a rectilineal motion; and then the flow proceeds to step 306.

Please refer to FIG. 3B, which shows a moving path of a robotic vacuum cleaner as it is being guided toward a service station by the use of the method of the invention. As seen in FIG. 3B, as soon as a robotic vacuum cleaner 51 reaches a location 80, it detects that it is low in electricity capacity, thus, the aforesaid steps 300 to 305 are to be performed thereby for enabling the robotic vacuum cleaner to located a moving direction pointing to the communication signal of maximum intensity for guiding the same to move toward a service station 50 in a rectilineal motion. It is noted that during the moving toward the service station 50, a movement confirmation process should be performed, as that indicated in step 306 which further comprises the steps of: confirming the intensity of the communication signal; and detecting whether there is an obstacle blocking the way the robotic vacuum cleaner is moving toward the service station while evaluating the distance between the robotic vacuum cleaner and the service station. Thereby, the robotic vacuum cleaner 51 is ensured to moved in a rectilineal motion following the direction pointing to the communication signal of maximum intensity.

Referring to FIG. 3B, during the processing of the movement confirmation process, the step 307 of FIG. 3A is performed when the robotic vacuum cleaner 51, moving in the rectilineal motion guided by the communication signal of maximum intensity, runs into an obstacle at location 81; and the step 308 is performed when the robotic vacuum cleaner 51 detected unreason signal intensity at location 82; and the step 309 is performed when the robotic vacuum cleaner detected that the distance between the robotic vacuum cleaner and the service station 50 is smaller than a specific value at location 83. At step 307, the robotic vacuum cleaner 51 is directed to enter an obstacle evading mode for maneuvering the same around the obstacles; and then the flow proceeds back to step 301. At step 308, an orientation calibration process is performed in the manner that the robotic vacuum cleaner 51 is being enabled to sway within in a specific angular range, e.g. ±10°, but is not limited thereby; and then the flow proceeds back to step 304. At step 309, the robotic vacuum cleaner 51 is directed to decelerate while moving in the rectilineal motion if the distance is smaller than a specific value, e.g. 0.5 m, but it can be determined with respect to actual requirement and thus is not limited thereby; and then the flow proceeds to step 310.

At step 310, an evaluation is being made to determining whether the electrode of the robotic vacuum cleaner 51 is coming into contact with a charging unit of the service station 50; if so, the flow proceeds to step 312; otherwise, the flow proceeds back to step 311. At step 311, the robotic vacuum cleaner 51 is re-positioned; and then the flow proceeds back to step 301. At step 312, the service station 50 begins to charge the robotic vacuum cleaner 51 through its charging unit; and then the flow proceeds to step 313. At step 313, the robotic vacuum cleaner 51 confirms the reception of electricity and thus it is directed to stop moving to be charged.

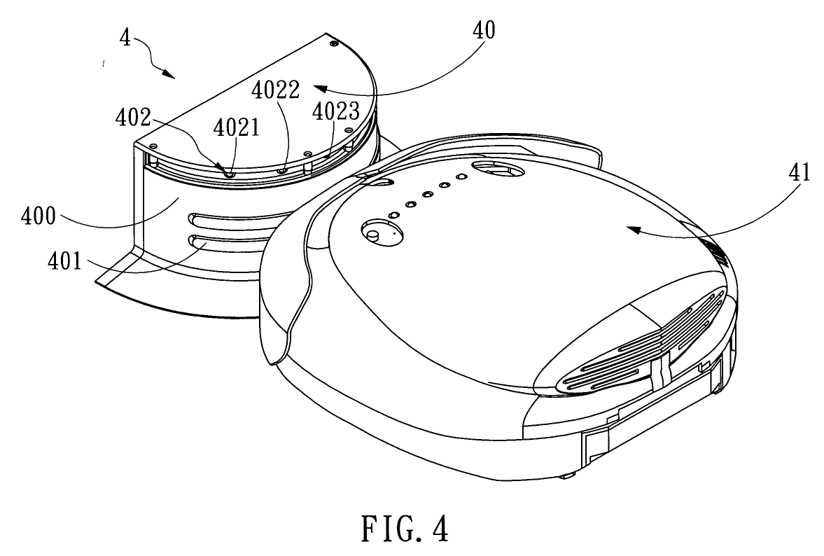

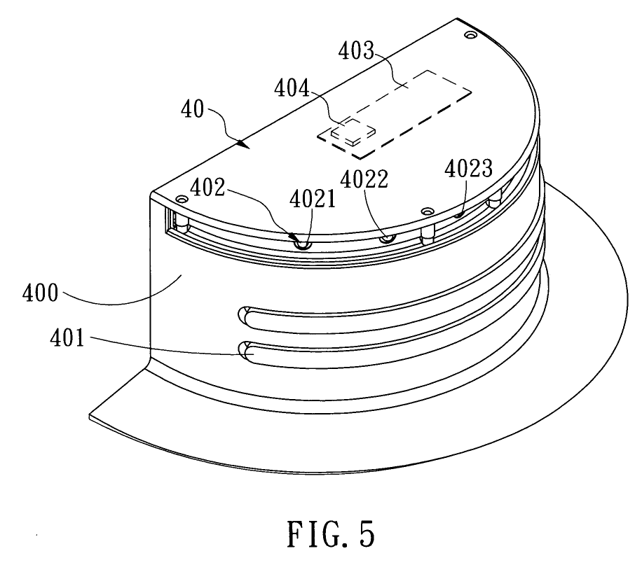

Please refer to FIG. 4, which is a schematic perspective view of a robotic apparatus service system according to an embodiment of the invention. In FIG. 4, a robotic apparatus service system 4 is comprised of: at least a service station 40 and at least a robotic apparatus 41. The service station 40 is designed to serve the robotic apparatus 41 as soon as the robotic apparatus arrives at the service station 40, whereas the services provided by the service station can include charging, air recharging, and so on. Please refer to FIG. 5, which is a schematic perspective diagram showing a service station used in a robotic apparatus service system of the invention. As seen in FIG. 5, the service station 40 is a charging station which is composed of: at least a signal emitter array 402, each being respectively arranged on at least a side of the service station 40 for structuring a communication zone by the communication signal emitted therefrom; at least a charging unit 401; and a control unit 404. In a preferred aspect, the communication signal emitted from each signal emitter array 402 can be an infrared signal.

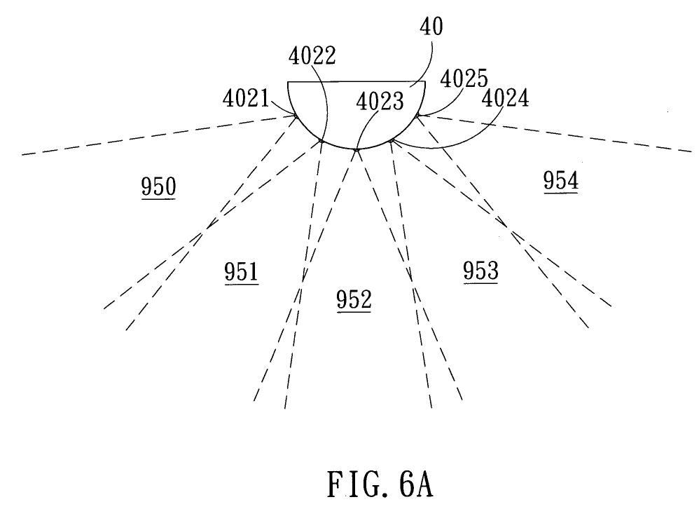

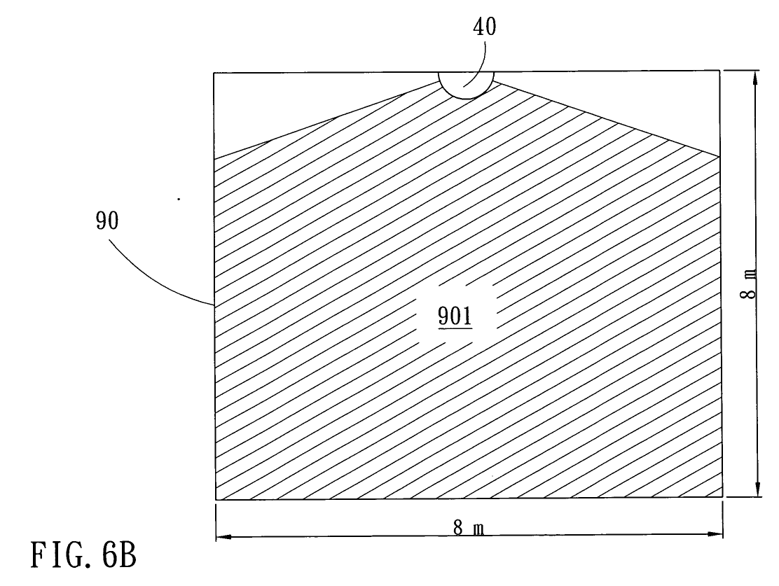

Please refer to FIG. 6A and FIG. 6B, which are schematic diagrams respectively showing the signal emitter array of a service station and the communication zones structured thereby. In FIG. 6A, the signal emitter array 402 is composed of a plurality of emitters, which can be infrared emitters. Although there are five emitters 4021, 4022, 4023, 4024, 4025 shown in FIG. 6A, it is only for illustration and the amount of emitters is not limited thereby. The five emitters 4021, 4022, 4023, 4024, 4025 are capable of structuring communication zones 950, 951, 952, 953, 954 in respective, and by the cooperation of the five communication zones 950, 951, 952, 953, 954, an integrated communication zone can be formed that it can cover a comparatively larger area for facilitating the robotic apparatus to receive the communication signal emitted from the signal emitter array of the service station 40. As seen in FIG. 6B, in a working area 90 defined within a 8 m×8 m square, the integrated communication zone of 120° included angle, formed by the signal emitter array of the five emitters 4021, 4022, 4023, 4024, 4025, will cover about 85% of the working area 90, that is represented by the shadowed area 901.

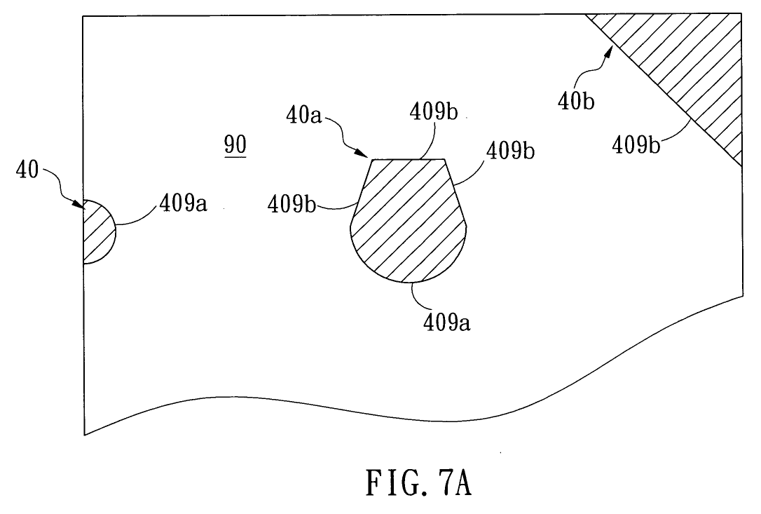

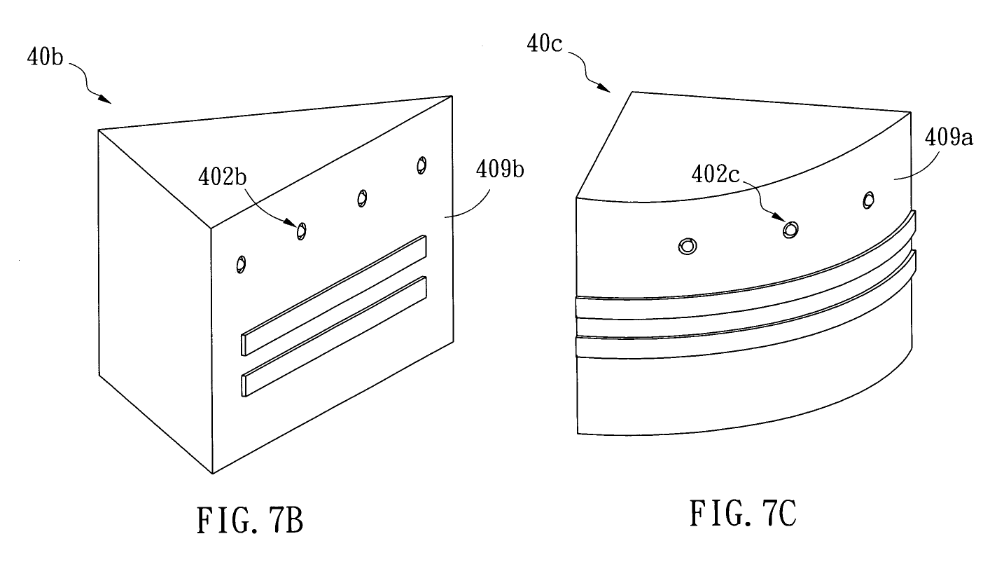

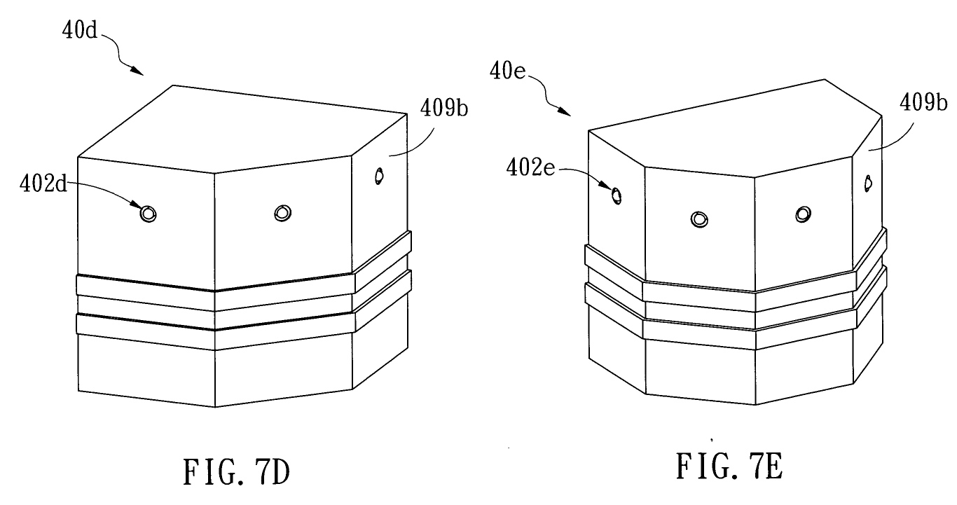

The signal emitter array can be arranged on a curved surface, a flat surface or the combination thereof, as illustrated in FIG. 7A. In the service station 40 shown in FIG. 7A, a signal emitter array is disposed upon its curved surface 409a. On the other hand, as the peripheral of the service station 40a is composed of a curved surface 409a and three flat surfaces 409b, the emitters of its signal emitter array can be disposed respectively upon the curved surface and flat surfaces 409b. In addition, as the service station 40b, which is designed to have a triangular shape as that shown in FIG. 7B, is arranged at a corner of a working area so that its signal emitter array 402b can be arranged on its flat surface 409b facing the working area.

The difference between the service station 40c of FIG. 7C and the service station 40b of FIG. 7B is that the flat surface 409b of the service station 40b facing toward the working area is replaced by a curved surface 409a so that in the service station 40c, its signal emitter array 402c is disposed upon the curved surface 409a. Moreover, the peripherals of the service stations 40d, 40e shown respectively in FIG. 7D and FIG. 7E are designed to be a polygon composed of a plurality of flat surfaces 409b, in which the emitters of their signal emitter arrays 402d, 402e can be disposed respectively upon those flat surfaces 409b. It is noted that the positioning of service station in a working area is dependent upon the environment ambient to the working area and decided by users. For instance, as seen in FIG. 7A, the service station 40 is being positioned against the wall while the service station 40b is being positioned at the corner, not to mention that the service station 40a is positioned in the middle of the working area while having peripheral being composed of curved surface 409a and flat surfaces 409b. It is noted that a corner-positioned service station can be lifted to a higher level so that its communication zone can be increased.

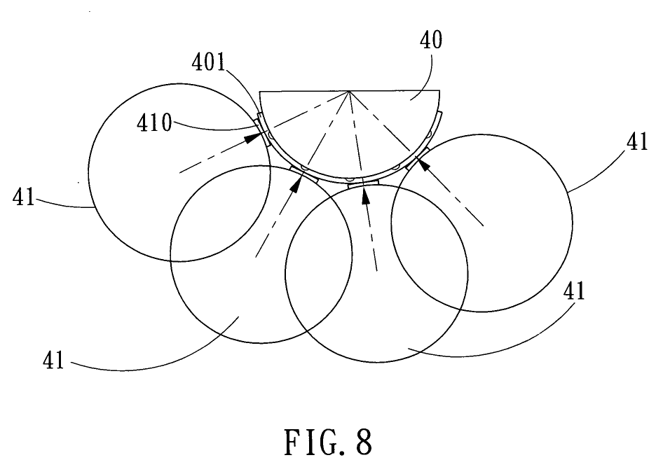

As seen in FIG. 5, a control unit 404 is mounted on a substrate 403, which is the neural center of the whole service station 40. As for other charging related components used in the service station 40 are the same to those commonly seen in prior-art charging station, and thus are not described further herein. The charging unit 401 is disposed in a manner that it is extending from one end of the curved surface 400 to another end thereof by a large angle, by which no matter the robotic apparatus is approaching toward the service station by which entrance angle, it can come into contact with the charging unit 401 as illustrated in FIG. 8. As seen in FIG. 8, by the large-angled extension of the charging unit 401, no matter the robotic apparatus 41, moving in a rectilineal motion, is approaching toward the service station 40 by which entrance angle, its electrode 410 can be oriented to be come into contact with the charging unit 401. It is noted that the alignment of the charging unit 401 of large-angled extension should match with the electrode design of its corresponding robotic apparatus 41, that is usually being disposed at a side the same as that of the signal emitter array so that the robotic apparatus 41 being guided to move toward the service station 40 by the communication signal of the signal emitter array in a rectilinear motion can easily come into contact with the charging unit 401 directly.

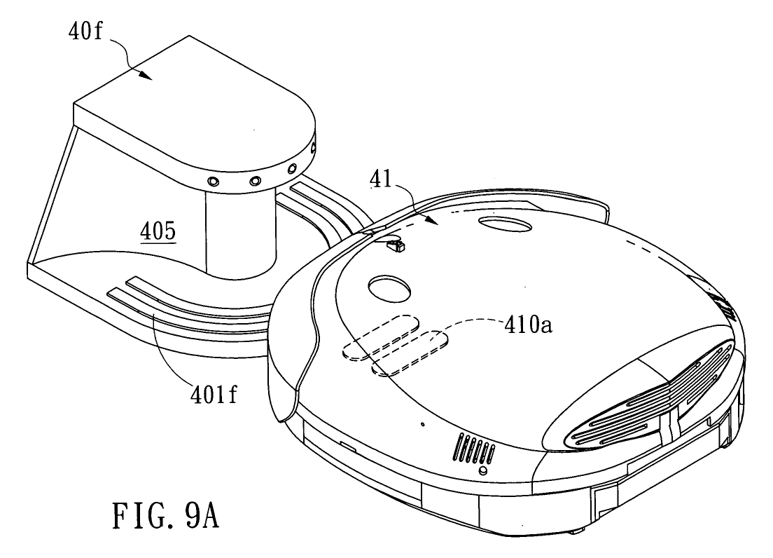

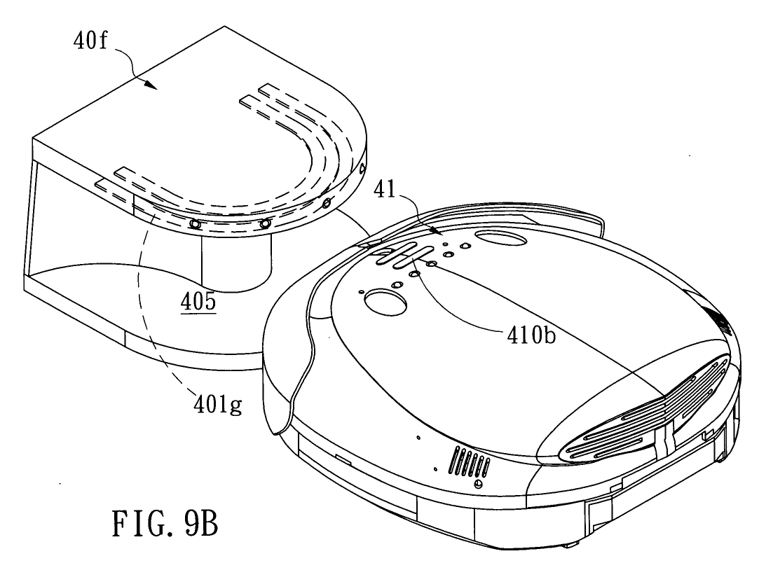

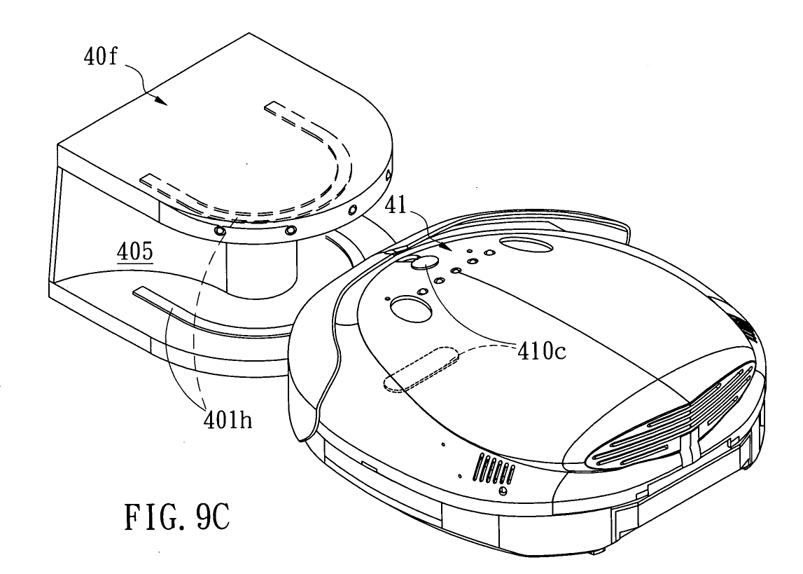

The positioning and arrangement of the charging unit 401 in the service station can have various choices. As seen in FIG. 9A, the service station 40f is further comprised of a concave 405 structured with a large-angled opening, as the 180° opening shown in FIG. 9A but is not limited thereby, which is used for receiving the robotic apparatus 41 as it is approaching the service station 40f at arbitrary angle. In the service station 40f, the charging unit 401f is disposed horizontally at the bottom of the concave 405, while correspondingly the electrode 410a of the robotic apparatus 41 is disposed at the bottom thereof. In the service station 40d shown in FIG. 9B, the charging unit 401g is disposed at the top of the concave' 405 opening, while correspondingly the electrode 410b of the robotic apparatus 41 is disposed at the top thereof. In addition, as seen in FIG. 9C, the charging unit 401h is composed of two portions, each being structured similar to the one-piece charging unit 401f of FIG. 9A, that are respectively being disposed at the top and bottom of the concave 405 of the service station 40f, while correspondingly the electrode 410c of the robotic apparatus 41, also being composed of two portions, are respectively disposed at the top and bottom thereof. The aforesaid arrangements of the charging unit in the service station shown are only used as illustrations and thus are not limited thereby. Operationally, the positioning of the electrode in the robotic apparatus is changed with respect to the position change of the charging unit.

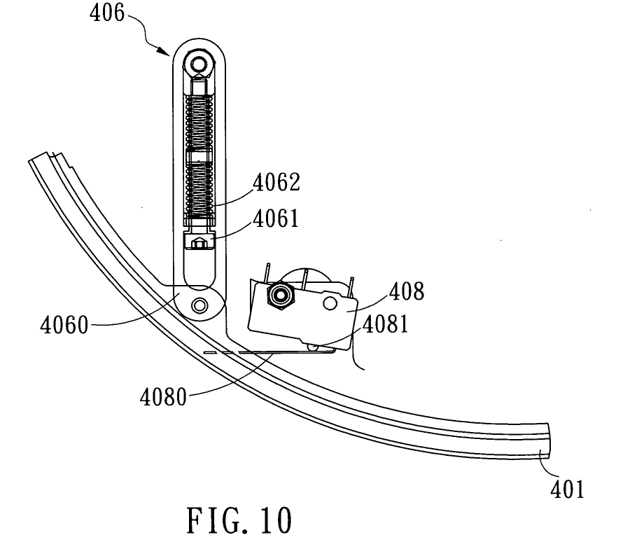

For providing the control unit with the ability to determine whether the robotic apparatus is in contact with the charging unit, at least a confirmation unit is disposed around the two sides of the charging unit 401, as seen in FIG. 10 where only one of the two sides is illustrated. The confirmation unit is electrically connected to the control unit for sending a sensing signal to the control unit to be used for controlling the charging of the charging unit 401. As seen in FIG. 10, the confirmation unit is a contact-type device capable of detecting the position of the charging device by a contact manner that the evaluation of determining whether the robotic apparatus is in contact with the charging unit 401 is made with respect to the position of the charging device 401. The confirmation unit includes a displacement mechanism 406 and a displacement sensor 408. The displacement mechanism 406 is connected to the charging unit 401 for providing a resilience force to be used by the charging unit 401 and thus recovering the charging unit 401 back to its original position. The displacement sensor 408, being electrically connected to the control unit, is capable of detecting the position of the charging unit 401 and thus transmitting the sensing signal to the control unit. In a preferred aspect, the displacement sensor can be a device selected from the group consisting of a photo interrupter switch, a contact switch, and a impedance detector capable of detecting the impedance variation of the charging unit through the service station while using the detection for charging confirmation.

The displacement mechanism is further composed of a base 4061, an elastic member 4062, and a connecting part 4060. The elastic member 40 is mounted on the base 4061, and the connecting part 4060 is connected to the charging unit 401 while abutting to the elastic member 4062 by an end thereof. When the electrode of the robotic apparatus is in contact with the charging unit 401, the charging unit 401 will be in contact with a reed 4080 of the displacement sensor 408 for pressing the reed 4080 against a switch 4081, by which a sensing signal is generated and transmitted to the control unit. By the reception of the sensing unit, the control unit is advised that the robotic apparatus had arrived at the service station so as to initiate a charging operation. When the charging unit 401 is being pressed to move by the contact of the robotic apparatus, the connecting part 4060 will be moved thereby by which the elastic member 4062 is compressed and thus a resilience force is generated. Therefore, as soon as the robotic apparatus leaves the service station, the resilience force will force the connecting part 4060 to move back to its original position, and thereby, force the charging unit 401 also back to its original position.

Except for the aforesaid contact-type sensing, the confirmation unit can be a non-contact sensor capable of detecting whether the robotic apparatus is in the neighborhood of the service station. The non-contact confirmation unit can be a device selected from the group consisting of: an electromagnetic induction device like a reed switch, a radio frequency (RF) communication device, and an audio control device. If a reed switch is selected to be used as the non-contact confirmation unit and is being arranged on a service station, a magnet should be disposed upon the robotic apparatus, so that as soon as the robotic apparatus is approaching and in the neighborhood of the service station, the reed switch, being induced by the magnetic force of the magnet, will issue a sensing signal to the control unit for controlling the charging of the charging unit. If a RF communication device is selected to be used as the non-contact confirmation unit, a RF receiver of the RF communication device should be arranged on a service station while the corresponding RF transmitter is arranged on the robotic apparatus, so that as soon as the robotic apparatus is approaching and in the neighborhood of the service station, the RF communication device will issue a sensing signal to the control unit the minute when the RF receiver receives a RF signal transmitted from the RF transmitter. When the audio control device is being selected, it is functioning similar to that of the RF communication device and thus is not described further herein. The confirming of the confirmation unit can be achieved by a contact manner or by a non-contact manner that are all known to those skilled in the art, so that the confirming of the confirmation unit is not limited by the aforesaid devices and applications.

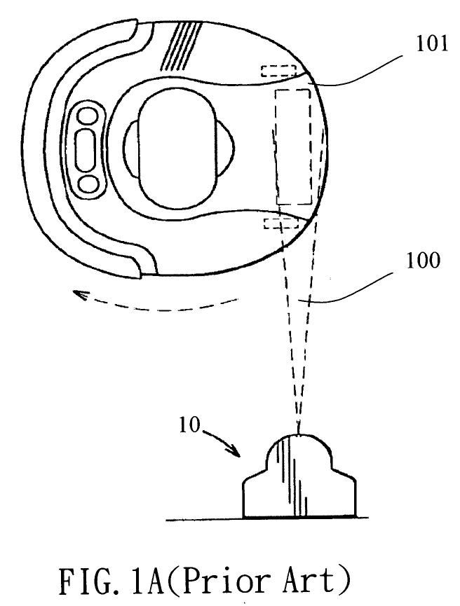

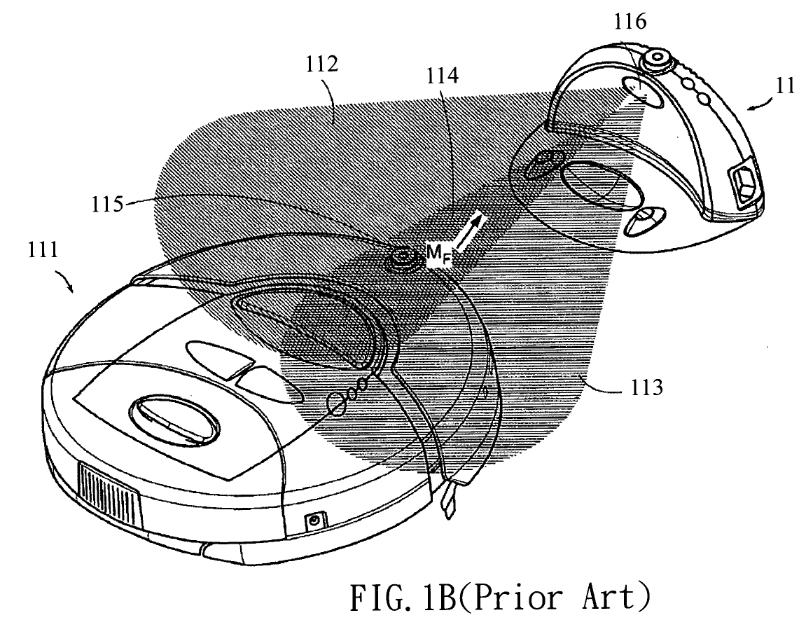

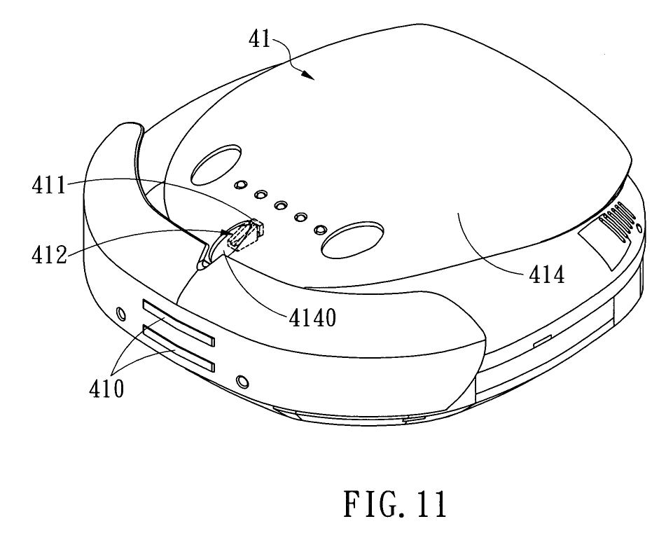

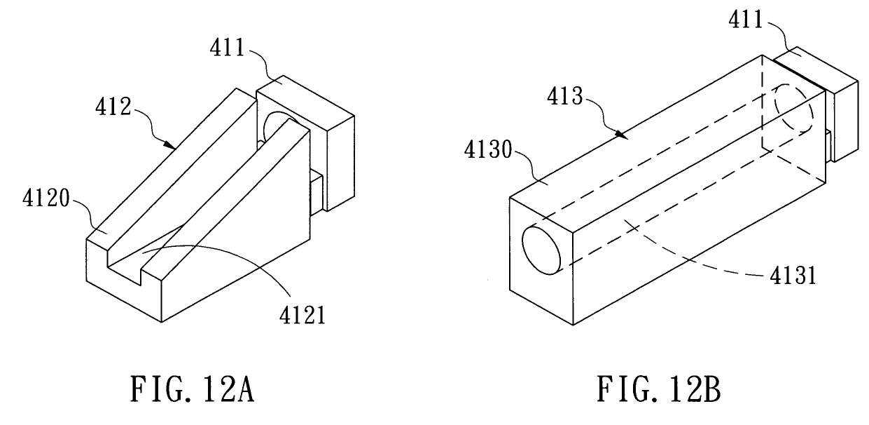

Please refer to FIG. 11, which is a schematic view of a robotic apparatus of the invention. The robotic apparatus 41 of FIG. 11 is comprised of a signal receiver 411 and an electrode 410. The signal receiver 411 is arranged inside the casing 414 of the robotic apparatus 41 in a manner that it is able to receive the communication signal through a hole 4140 formed on the casing 414. It is noted that the signal receiver 411 can be an infrared receiver, and its arrangement is not limited by the aforesaid embodiment shown in FIG. 11. For matching with the position of the charging unit, the electrode 410 is disposed at the front of the robotic apparatus 41. Moreover, a directional unit 412 is arranged at a side of the signal receiver 411, by which the communication zone of the signal receiver is restricted and thus narrowed so as to direct the robotic apparatus to move toward the service station more directly and accurately. Please refer to FIG. 12A and 1B, which are schematic perspective views of a signal receiver and its directional unit, used in a robotic apparatus of the invention. In FIG. 12A, the directional unit 412 is further comprised of: a base 4120 and a slot 4121. The base 4120 is disposed at the front of the signal receiver 411. The slot 4121 is formed on the base 4120 while positioning the same to correspond with the signal receiver 411, through which a communication signal can pass and be received by the signal receiver 411. It is noted that the width of the slot is dependent upon actual requirement. In FIG. 12B, the directional unit 413 is further comprised of: a base 4130 and a via hole 4131. Similarly, the base 4130 is disposed at the front of the signal receiver 411. The via hole 4131 is also formed on the base 4130 while positioning the same to correspond with the signal receiver 411.

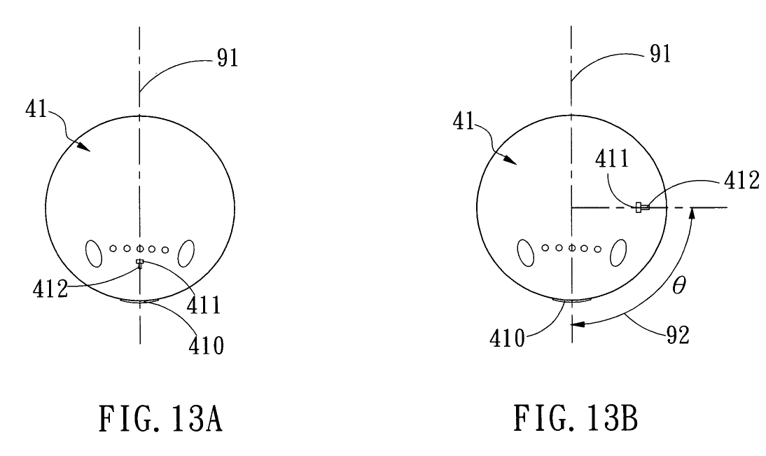

Please refer to FIG. 13A and FIG. 13B, which are schematic top views respectively showing two different arrangements for mounting signal receivers upon a robotic apparatus of the invention. There can be various arrangements for mounting signal receivers upon a robotic apparatus of the invention. In FIG. 13A, the signal receiver 411 is arranged on the symmetrical centerline 91 of the robotic apparatus while aligning the pointing direction of the directional unit 412, usually being the direction that the centerline of the slot/via hole is pointing, with the centerline 91. Thereby, when a robotic apparatus 41 is low in battery and requiring to be charged, it will be directed to rotate without moving for searching the infrared communication signal issued from the service station. As soon as the control unit of the robotic apparatus 41 located the direction pointing to the service station, the robotic apparatus 41 can be directed to move toward the service station in a rectilinear motion. In FIG. 13B, instead of being arranged at the symmetrical centerline 91, the signal receiver 411 can be arranged at any position of the robotic apparatus 41 only if the included angle θ formed between the symmetrical centerline 91 and the axial of the signal receiver 411 is previously recorded. Thereby, as soon as the moving direction pointing to the communication signal of maximum intensity is located, a rotation 92 can be performed for compensating the deviation with respect to the included angle θ so that the robotic apparatus 41 can be directed to move toward the service station in a rectilinear motion.

To sum up, by the method for routing a robotic apparatus to a service station and the robotic apparatus service system using the same, not only the robotic apparatus can be guided back to the service station in a shortest way efficiently to be served thereby, but also the robotic apparatus can be routed back to the service station to be served thereby in arbitrary angle since the robotic apparatus service system is able to provide a communication zone with high coverage. It is further to be noted that although a robotic vacuum cleaner is used as an illustration in the present invention, the method and system of the invention are more versatile that it can be adopted by many other applications and thus are not limited by the aforesaid robotic vacuum cleaner and its charging station.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A method for routing a robotic apparatus to a service station, comprising the steps of:
enabling a robotic apparatus to search for a communication signal emitted from a service station;
enabling the robotic apparatus to rotate for locating a moving direction pointing to the communication signal of maximum intensity;
directing the robotic apparatus to move toward the service station by the guidance of the moving direction; and
making an evaluation by a manner selected from the group consisting of a contact manner and a non-contact manner to determining whether the robotic apparatus reaches the service station, while directing the service station to serve the robotic apparatus if the robotic apparatus reaches the service station.

2. The method of claim 1, wherein the robotic apparatus is able to search for a communication signal by a manner selected from the group consisting of: searching the communication signal dynamically while the robotic apparatus is on the move, directing the robotic apparatus to rotate without moving while searching the communication signal, and the combination thereof.

3. The method of claim 1, wherein the service station is a charging station composed of a charging unit.

4. The method of claim 1, wherein a movement confirmation process is being performed during the robotic apparatus is being directed to move toward the service station, the movement confirmation process comprising the steps of:
confirming the intensity of the communication signal; and
enabling the robotic apparatus to perform an orientation calibration process while detecting unreasonable signal intensity.

5. The method of claim 4, wherein the orientation calibration process is performed in the manner that the robotic apparatus is being enabled to sway within in a specific angular range.

6. The method of claim 1, wherein a movement confirmation process is being performed during the robotic apparatus is being directed to move toward the service station, the movement confirmation process comprising the steps of:
making an evaluation to determine whether the robotic apparatus is colliding with an obstacle; and
enabling the robotic apparatus to enter an obstacle evading mode for maneuvering the same around the obstacle while the robotic apparatus is colliding with the obstacle.

7. The method of claim 1, wherein a movement confirmation process is being performed during the robotic apparatus is being directed to move toward the service station, the movement confirmation process comprising the steps of:
evaluating the distance between the robotic apparatus and the service station; and
directing the robotic apparatus to decelerate while moving in the rectilinear motion if the distance is smaller than a specific value.

8. The method of claim 7, wherein the distance between the robotic apparatus and the service station is being evaluated with respect to the intensity of the communication signal.

9. A robotic apparatus service system, comprising:
at least a service station;
at least a signal emitter array, each being composed of a plurality of emitters and each being respectively arranged on a side of the at least one service station for structuring a communication zone by communication signals emitted therefrom while the side can be a surface selected from the group consisting of a flat surface, a curved surface and the combination thereof;
a robotic apparatus, having a signal receiver and an electrode; and
at least a charging unit, each being disposed on the at least one service station, capable of electrically connecting to the electrode of the robotic apparatus in arbitrary angle for charging the robotic apparatus;
wherein the signal receiver is able to receive the communication signals as soon as the robotic apparatus enters the communication zone so as to direct the robotic apparatus to move toward the service station by the guidance of the communication signals.

10. The robotic apparatus service system of claim 9, wherein each emitter is an infrared emitter.

11. The robotic apparatus service system of claim 9, wherein each service station further comprises:
a control unit; and
at least a confirmation unit, each electrically connecting to the control unit, capable of issuing a sensing signal to the control unit for directing the control unit to control the charging of the charging unit.

12. The robotic apparatus service system of claim 11, wherein the confirmation unit is capable of evaluating and thud detecting the positioning of the at least one charging unit, thereby, it is able to make an evaluation to determine whether the robotic apparatus is in contact with the at least one charging unit, and the confirmation unit is further comprised of:
a displacement mechanism, connected to the at least one charging unit for providing a resilience force to be used by the at least one charging unit and thus recovering the at least one charging unit back to its original position; and
a displacement sensor, electrically connected to the control unit, capable of detecting the position of the at least one charging unit and thus transmitting the sensing signal to the control unit.

13. The robotic apparatus service system of claim 12, wherein the displacement mechanism further comprises:
a base;
an elastic member, mounted on the base; and
a connecting part, connected to the at least one charging unit while abutting to the elastic member by an end thereof.

14. The robotic apparatus service system of claim 11, wherein the confirmation unit is substantially a non-contact sensor, being a device selected from the group consisting of a magnetic reed switch, a radio frequency communication device and an audio control device, capable of detecting whether the robotic apparatus is in the neighborhood of the at least one charging unit.

15. The robotic apparatus service system of claim 9, wherein a curved surface is formed on a side of the at least one service station for enabling the at least one charging unit to be disposed on the curved surface following the curvature thereof.

16. The robotic apparatus service system of claim 15, wherein the electrode is arranged on the symmetrical centerline of the robotic apparatus at a position right on the edge of an end surface of the casing of the robotic apparatus.

17. The robotic apparatus service system of claim 9, wherein each service station is further comprised of a concave, used for receiving the potion of the robotic apparatus containing the electrode, in which the at least one charging unit is disposed with respect to the defining of an opening of the concave at a position selected from the group consisting of: a bottom of the concave, a top of the concave, and both of the aforesaid top and bottom.

18. The robotic apparatus service system of claim 9, wherein a directional unit is arranged in the front of the signal receiver to be used for defining the signal receiving range of the signal receiver, and the directional unit is further comprised of:
a base, disposed in the front of the signal receiver; and
a via hole, formed on the base while positioning the opening of the via hole to correspond with the signal receiver.

19. The robotic apparatus service system of claim 9, wherein a directional unit is arranged in the front of the signal receiver to be used for defining the signal receiving range of the signal receiver, and the directional unit is further comprised of:
a base, disposed in the front of the signal receiver; and
a slot, formed on the base while positioning the same to correspond with the signal receiver.

20. The robotic apparatus service system of claim 9, wherein the signal receiver is arranged on the symmetrical centerline of the robotic apparatus.
